(19) United States
(12) Patent Application Publication
(10) Pub. No.: US 2025/0064043 A1
(43) Pub. Date: Feb. 27, 2025

(54) FISHING ROD HOLDER ASSEMBLY

(71) Applicant: Darryl Paul SMITH, Carina (AU)

(72) Inventor: Darryl Paul SMITH, Carina (AU)

(21) Appl. No.: 18/811,981

(22) Filed: Aug. 22, 2024

(30) Foreign Application Priority Data
Aug. 22, 2023 (AU) 2023902668

(51) Int. Cl. A01K 97/10; A01K 97/04; A45F 3/44

(52) U.S. Cl. CPC A01K 97/10; A01K 97/04; A45F 3/44

(57) ABSTRACT

The application is a fishing rod holder assembly with a rod holding portion and a staking assembly having a first and ground staking member that connect together. The rod holding portion has a passage to hold the handle end of a fishing rod, while the staking member has one end for engaging the ground and another end for connecting to the holding portion. It can securely hold the fishing rod in position by connecting to the rod holding portion and engaging the ground surface.

### CROSS-REFERENCE TO RELATED APPLICATIONS

This application claims the benefit of priority to Australian Patent Application Number 2023902668 filed on Aug. 22, 2023. The entire contents of the above-identified application are hereby incorporated by reference.

### TECHNICAL FIELD

The present invention relates to a fishing rod holder, which supports the position of a fishing rod without the need for the user to physically hold the fishing rod, particularly when fishing on land.

### BACKGROUND

There are many reasons why it is desirable for fisherman to utilise a fishing rod holder, not least of which, it allows the fisherman to multi-task without the need to constantly hold the fishing rod in position. For example, it allows the fisherman to bait a hook, change a lure or fly, unhook a fish, use multiple rods at the same time or undertake other similar tasks. Having the ability to secure the fishing rod in place so that the fisherman can perform any of the above actions, or more, without removing the line from the water or creating any unexpected movements in the bait, is therefore extremely invaluable, since such movements could reduce the chances of catching a fish.

Often when fishermen are out at sea, the boat would typically house fixtures that would allow for the fisherman to securely place their fishing rod therein, so that the fisherman may be hands-free. However, on land, where fishermen undertake activities such as, but not limited to, rock fishing, beach fishing and shore fishing, conventionally the fisherman will attempt to secure the fishing rod to their body, whether this be on a belt, shirt, trousers, creel or any other suitable part on the fisherman's garment, which is inconvenient.

It is important that when storing a fishing rod, the rod holder should provide enough protection so as to minimize any risk of damaging the equipment, given that fishing rods are generally quite costly and delicate.

It can also be difficult for groups of fishermen to identify their own rod holders.

Embodiments of the present disclosure seek to provide a means for protecting, storing and securing a fishing rod in place, so that a fisherman can maintain the position of a fishing hook and line, without having to physically hold the fishing rod, or attach it to themselves whilst land fishing.

Any references to methods, apparatus or documents of the prior art are not to be taken as constituting any evidence or admission that they formed, or form part of the common general knowledge.

### SUMMARY OF INVENTION

In one aspect of the present invention, there is provided a fishing rod holder assembly comprising:
a rod holding portion comprising a body having a rod passage for receiving a handle end of a fishing rod; and
a staking member comprising:
   a first end for engaging a ground surface;
   a second end for connecting to the holding portion; and
   a foothold oriented substantially perpendicular to a longitudinal axis of the staking member,
wherein the staking member is configured to releasably connect with the rod holding portion via a connecting arrangement, and
wherein the second end of the staking member engages the ground surface to secure the fishing rod in position.

In a preferred embodiment, the rod holding portion comprises a resilient collar that abuts or receives an end of the body and wherein the resilient collar defines a passage for receiving the handle end of the fishing rod therethrough such that, in use, the handle end of the fishing rod passes through the passage of the resilient collar and is received within the rod passage.

Preferably, the resilient collar is removable.

Preferably, the connecting arrangement comprises a staking passage formed in the body of the rod holding portion and a fastening assembly, wherein the staking member extends through the staking passage and the fastening assembly connects to the staking member for securing the rod holding portion along the staking member.

Preferably, the staking passage of the rod holding portion is threaded and the staking member is threaded so that the two engage.

In a preferred embodiment, the foothold is located between the first and second end of the staking member.

Even more preferably, the rod holding portion comprises visual indicia on its exterior surface. Preferably, the visual indicia comprises reflective tape.

In a preferred embodiment, the second end of the staking member for engaging the ground surface is tapered. Preferably, the staking member is resistant to corrosion. More preferably, the staking member is aluminium.

In another preferred embodiment, the fastening assembly is aluminium.

Preferably, the passage of the body is open at one end for receiving the handle end of the fishing rod.

In a further preferred embodiment, the rod holding portion further comprises a storage compartment for receiving accessories therein.

Preferably, the storage compartment is positioned between the rod holding portion and the staking member of the fishing rod holder. Even more preferably, the storage compartment has an open upper end. Most preferably, the storage compartment is a slot.

In another preferred embodiment, the foothold is adjustably positionable along the staking member.

In a further preferred embodiment, the staking member further comprises a handle.

In a preferred embodiment, a clip may be removably attached to the foothold and/or handle for connecting to and holding an external accessory. Preferably, the external accessory may be a bait bucket.

Preferably, a colour of a rod holding portion matches a colour of the resilient collar and/or a colour of a protective layer of the foothold.

Preferably, the staking member is a separable member. Preferably, the staking member comprises a first threaded member and a second substantially unthreaded member connected by a connecting arrangement. Preferably, the connecting arrangement comprises a threaded hex nut. Preferably, the second substantially unthreaded member comprises a threaded portion at an end to be received within the hex nut.

Preferably, the assembly further comprises an extension member and an additional upper staking member, wherein the extension member connects the upper staking member to the additional upper staking member, and the additional upper staking member is connected to the ground staking member

In another aspect, the invention provides a kit of parts for a fishing rod holder comprising:
a rod holding portion comprising a body having a rod passage for receiving a handle end of a fishing rod, a storage compartment for storing accessories; and
a staking member comprising:
   a first end for engaging a ground surface;
   a second end for connecting to the holding portion; and
   a foothold oriented substantially perpendicular to a longitudinal axis of the staking member,
wherein the staking member is configured to releasably connect with the rod holding portion via a connecting arrangement,
wherein the second end of the staking member engages the ground surface to secure the fishing rod in position.
wherein the storage compartment is integrated into the holding portion of the fishing rod holder.

In another aspect, the present invention provides a method of using a fishing rod holder, wherein a handle end of a fishing rod is inserted into a rod holding portion of the fishing rod holder, the rod holding portion comprising a body having at least one open end that provides access to a rod passage for receiving the handle end of the fishing rod,
releasably connecting a first end of a staking member with the rod holding portion via a connecting arrangement,
inserting a second end of the staking member to engage with a ground surface, using a foothold oriented substantially perpendicular to a longitudinal axis of the staking member, to secure the fishing rod holder in position.

In another aspect of the present invention, there is provided a fishing rod holder assembly comprising:
a rod holding portion comprising a body having a rod passage for receiving a handle end of a fishing rod; and
a staking assembly comprising:
   an upper staking member having a first end for connecting to the holding portion and a second end for connecting to another staking member; and
   a ground staking member having a first end for connecting to another staking member and a second end for engaging a ground surface,
   wherein:
      the second end of the upper staking member is connected to the first end of the ground staking member,
      the upper staking member is configured to releasably connect with the rod holding portion via a connecting arrangement, and
      in use, the first end of the ground staking member engages
   the ground surface to secure the fishing rod in position.

In another aspect of the present invention, there is provided a fishing rod holder assembly comprising:
a rod holding portion comprising a body having a rod passage for receiving a handle end of a fishing rod; and
a staking assembly comprising:
   an upper staking member having a first end for connecting to the holding portion and a second end for connecting to another staking member; and
   a ground staking member having a first end for connecting to another staking member and a second end for engaging a ground surface,
   wherein:
      the second end of the upper staking member is releasably connected to the first end of the ground staking member,
      the upper staking member is releasably connected to the rod holding portion via a connecting arrangement.

In another aspect, the present invention provides a method of using a fishing rod holder, wherein a handle end of a fishing rod is inserted into a rod holding portion of the fishing rod holder, the rod holding portion comprising a body having at least one open end that provides access to a rod passage for receiving the handle end of the fishing rod,
releasably connecting a first end of a staking member with the rod holding portion via a connecting arrangement,
inserting a second end of the staking member to engage with a ground surface to secure the fishing rod holder in position.

In another aspect, the present invention provides a method of assembling a fishing rod holder, the method including:
providing a staking assembly comprising an upper staking member having a first end and a second end and a ground staking member having a first end and a second end;
providing a rod holding portion, the rod holding portion including a body having a rod passage configured to receive a handle end of a fishing rod, wherein the rod holding portion is connected to the first end of the upper staking member;
connecting the second end of the upper staking member to the first end of the ground staking member; and
engaging the second end of the ground staking member with a ground surface to secure the fishing rod holder in position.

Preferably, the method includes connecting the first end of the upper staking member to the rod holding portion.

In another aspect of the present invention, there is provided a fishing rod holder assembly comprising:
a rod holding portion comprising a body having a rod passage for receiving a handle end of a fishing rod;
a removable resilient collar that receives an end of the body of the rod holding portion defines a passage for receiving the handle end of the fishing rod therethrough such that, in use, the handle end of the fishing rod passes through the passage of the resilient collar and is received within the rod passage; and
a staking assembly comprising:
   an upper staking member having a first end for connecting to the holding portion and a second end for connecting to another staking member; and
   a ground staking member having a first end for connecting to another staking member and a second end for engaging a ground surface,
   wherein:
      the second end of the upper staking member is connected to the first end of the ground staking member,
      the upper staking member is configured to releasably connect with the rod holding portion via a connecting arrangement, and
      in use, the first end of the ground staking member engages the ground surface to secure the fishing rod in position.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a fishing rod holder assembly according to an embodiment of the present invention.

FIG. 2 is a perspective view of a fishing rod holder, in its unassembled configuration.

FIG. 3 illustrates a side view of the fishing rod holder, in its unassembled configuration.

FIG. 4 represents a top-down view of the fishing rod holder.

FIG. 5 illustrates a partially assembled fishing rod holder, with the staking assembly attached and the resilient collar left unattached.

FIG. 6 illustrates a perspective back view of a fully assembled fishing rod holder, presented in its in-use configuration.

FIG. 7 illustrates a side view of a fully assembled fishing rod holder, presented in its in-use configuration.

FIG. 8 illustrates one embodiment of a bait holder attached to the foothold of the staking assembly.

FIG. 9 illustrates one example of a working embodiment of the present invention, whereby a fishing rod is securely fitted into the rod holding portion of the fishing rod holder, together with a bait bucket being attached to the foothold of the staking assembly of the fishing rod holder assembly.

FIG. 10 shows a fishing rod holder assembly according to an embodiment of the present invention.

FIG. 11 shows an exploded view of the fishing rod holder assembly of FIG. 10.

FIG. 12 shows a perspective view of the rod holding portions of the fishing rod holder.

FIG. 13 shows a top view of the rod holding portion shown in FIG. 12.

FIG. 14 shows a side view of the rod holding portion shown in FIG. 13.

FIG. 15 shows the collar used with the rod holding portion.

FIG. 16 shows the staking assembly of the fishing rod holder.

FIG. 17 shows an exploded view of the staking assembly.

FIG. 18 shows an extension member that can be used with the staking assembly.

FIG. 19 shows another embodiment of the fishing rod holder having a bait board and foothold attached.

### DETAILED DESCRIPTION OF PREFERRED EMBODIMENTS

Embodiments of the present disclosure provide a means for protecting, storing and securing a fishing rod in place, so that a fisherman can maintain the position of a fishing hook and line, without having to physically hold the fishing rod, or attach it to themselves whilst land fishing.

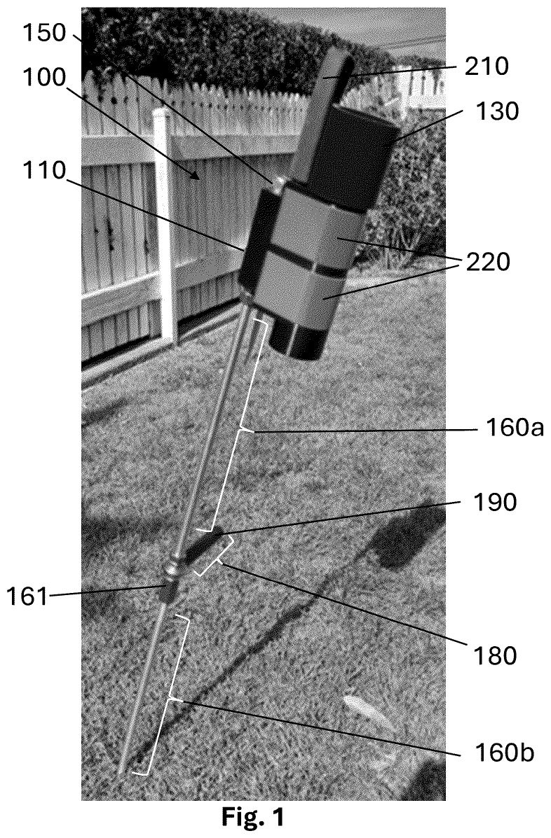

With reference to FIGS. 1 to 9, a fishing rod holder assembly (100) is shown. The fishing rod holder assembly 100 includes a rod holding portion (110) includes a body (115) with a rod passage (120) for receiving a fishing rod handle and a staking assembly (140) in the form of a plurality of staking members for connecting to and orienting the rod holding portion (110) relative to the ground (or another surface).

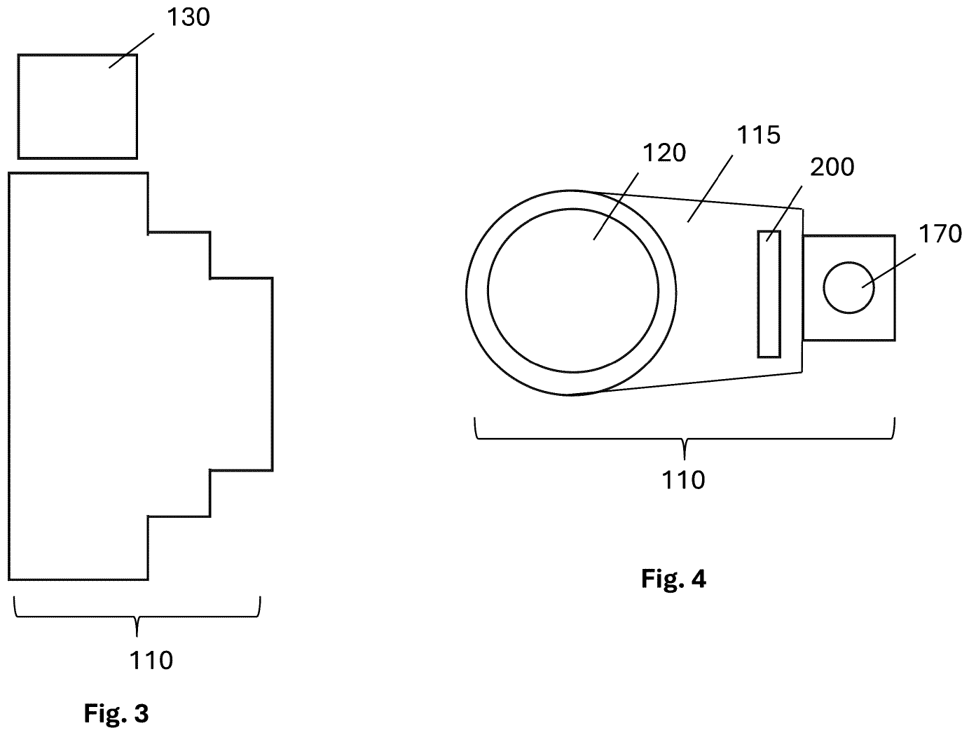

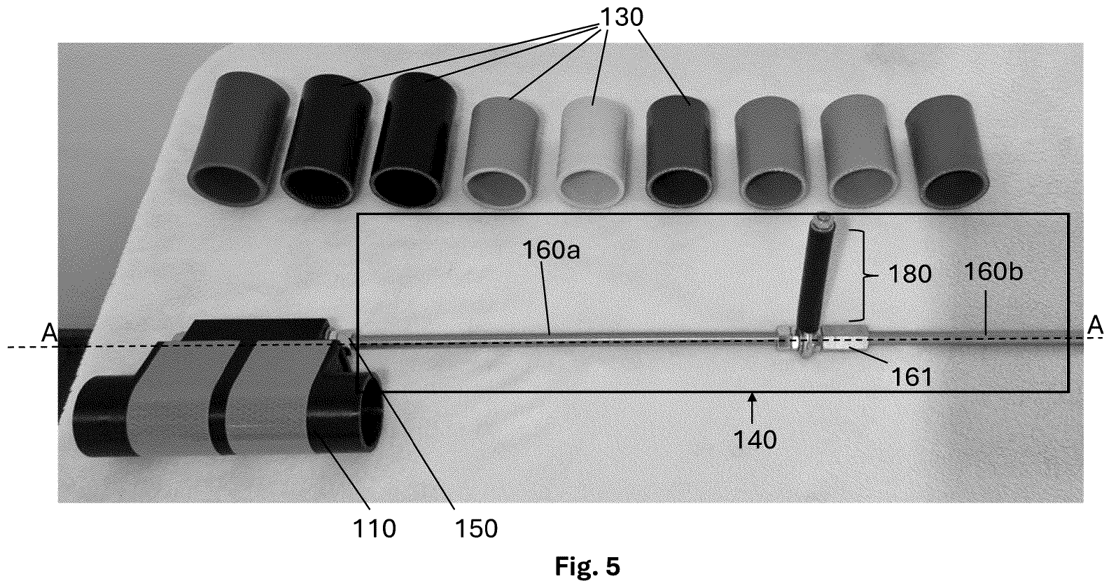

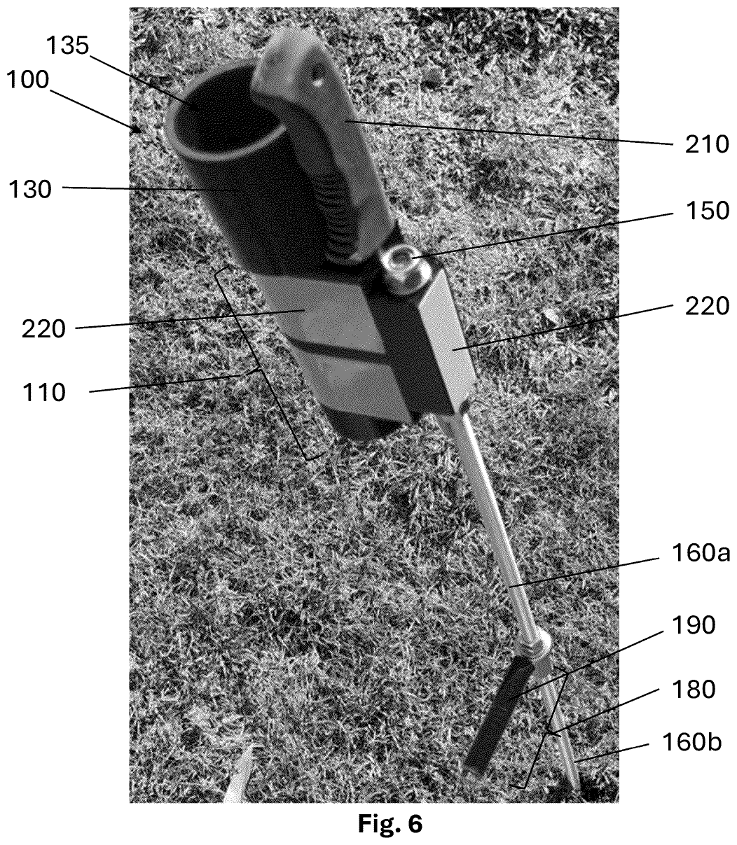

At one end of the rod passage (120) there may be a resilient collar (130), having a passage (131) therethrough (FIG. 4). The resilient collar (130) may be removable and may be placed to abut or received an end of the upper end of the rod passage (120) in a way that aligns the passage (131) of the resilient collar (130) with the rod passage (120), such that the handle end of the fishing rod may pass through the passage of the resilient collar (130) before being received within the rod passage (120) (see FIGS. 3 and 5). The resilient collar (130) may be made of, or lined with, any suitable material that provides a cushioning and supportive effect whilst maintaining its shape without being substantially deformed by the application of pressure. In particular, the resilient collar (130) should minimally deform or compress when pressure when pressure or forced is applied at the ends of the resilient collar (130). For example, the resilient collar (130) may be made of rubber and/or have a rubber lining along at least a portion of the interior passage of the collar. Other types of materials that may also be used include for example, shape-memory polymer materials, such as polyurethane or synthetic foam or a lining made of the same, various resilient plastics or gel-like materials may also be used.

The rod holding portion (110) and the resilient collar (130) may be provided in a range or variety of colours such that the rod holding portion (110) can be matched to a resilient collar (130) having the same colour, or different colour combinations can be used to provide distinction between other rod holders that may be in use, such as when a group of fishermen are fishing together or a family has multiple rod holders (FIG. 5).

The rod holding portion (110) may be reversible, in that the rod holding portion (110) may be inverted during use such that the fishing rod handle may be fitted into the rod passage (120) on either end of the rod holding portion (110), when the rod passage (120) extends therethrough, from one side of the rod holding portion (110) through to the other (see FIG. 3). Advantageously, this feature permits the re-use of the rod holding portion (110) in the event that the one end of the rod holding portion (110) is chipped, cracked or otherwise damaged, or the resilient collar (130) may no longer be held securely within the rod holding portion (110). Under these circumstances, the user may simply invert the rod holding portion (110) to continue fishing, rather than to abandon the rod holding portion (110) altogether.

The purpose of the resilient collar (130) is to provide a cushioning layer between the reel and the rod holding portion (110). In use, the resilient collar (130) aligns the fishing rod handle in a central position as the fishing rod handle is being inserted and received by the rod passage (120). Simultaneously, the resilient collar (130) serves to provide a cushioning effect to prevent the reel from being scratched as it slides into the rod passage (120). As mentioned above, the resilient collar (130) is to be placed on top of the rod holding portion (110) and may be lined on its exterior and/or interior sides with a resilient material. In the presence of a resilient lining, the diameter of the interior passage (135) of the resilient collar (130) would preferably be narrower relative to the diameter of the rod passage (120), which ensures that the fishing rod handle is aligned centrally within the rod passage (120), thus minimizing scratching or other forms of physical damage as the fishing rod handle moves relative to movement or force that may be exerted by the pulling of fish caught on the fishing line (FIG. 5).

The resilient collar (130) may be of any suitable length or shape, although in a preferred embodiment shown in the figures, the resilient collar (130) is substantially tubular.

In another embodiment, resilient collar (130) may have a profile whereby the first end of the resilient collar (130), which is most peripheral to the rod holding portion (110), may be outwardly flared at its end to accommodate further bending of the fishing rod, without the fishing rod having to bend across a sharp edge. In other embodiments, the resilient collar (130) may get progressively narrower to ensure a tighter fit of the fishing rod handle within the rod passage.

The rod holding portion (110) may be secured in position by a staking assembly (140). The staking assembly (140) may be any suitable means that would permit securing the fishing rod holder to the ground surface when the staking assembly (140) is fitted via a connecting arrangement to the rod holding portion (110) (FIG. 5).

The staking assembly (140) may include one or more staking members (160, 160a, 160b), which may be a spike, stake or may be pronged at one end to allow a user to insert and anchor the tapered end into the ground to a sufficient depth so that the fishing rod holding portion (110) will be secured to sufficiently support and hold the weight of a fishing rod held within the fishing rod holder (FIGS. 1, 5-7, 9).

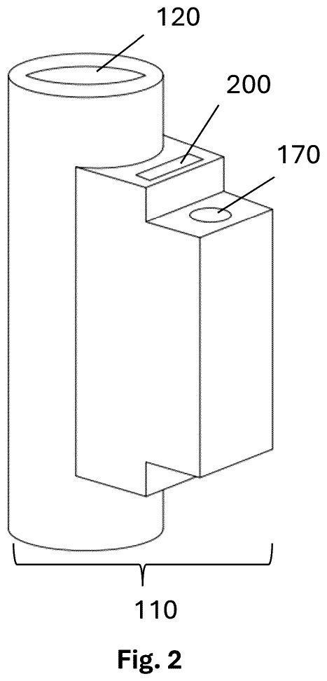

The connecting arrangement may include the rod holding portion (110) having a staking passage (170) within its body for receiving a staking member (FIGS. 2 and 4). The connecting arrangement may further comprise a fastening assembly (150) that coordinates with the upper staking member (160a) to releasably secure the rod holding portion (110) along a length of the upper staking member (160a), via the staking passage (170), at a desired height.

In some embodiments, the staking passage (170) and the upper staking member (160a) are both threaded so that the two can engage. In one embodiment, the upper staking member (160a) may be threaded on one peripheral end to permit the upper staking member (160a) to engage with the staking passage (170). For example, the peripheral end of the upper staking member (160a) may be threaded for a length of 40 mm or for any other suitable length. The opposite peripheral end of the upper staking member (160a) may have a plain finish without being threaded.

In another embodiment of the present invention, the staking passage (170) may extend throughout the length of the rod holding portion (110) (FIG. 1,6-9).

The fastening assembly (150) may be any suitable means, for example a nut or a clip to clamp the rod holding portion at a desired height along the length of the staking member (FIG. 6).

Preferably, in use, the staking assembly (140) will be inserted to a depth within the ground so as to prevent the staking assembly (140) from becoming dislodged by strong winds or other accidental physical force, including any pulling force exerted by the pulling of fish on the fishing line, or even from the weight of the fishing rod itself when contained within the fishing rod holder. As such, it is preferred that the staking assembly (140) may comprise a plurality of interconnecting parts, for example at least one staking member (upper staking member 160a and ground staking member 160b, for example) capable of interconnecting with one another, so that the user can adjust the height of the staking member (FIGS. 1, 5-7, 9). This is especially useful when a user seeks to insert the staking assembly (140) into loose surface types such as on sandy beaches, rocky shores or in loose soil. In addition, the staking assembly (140) may further comprise a foothold (180) or handle (discussed later) to assist with inserting the staking assembly (140) into the ground (FIG. 5). While referred to as a foothold, it will be understood that the foothold may be used as a foothold for driving the staking assembly into the ground but could also be used as a handle or handhold, as required.

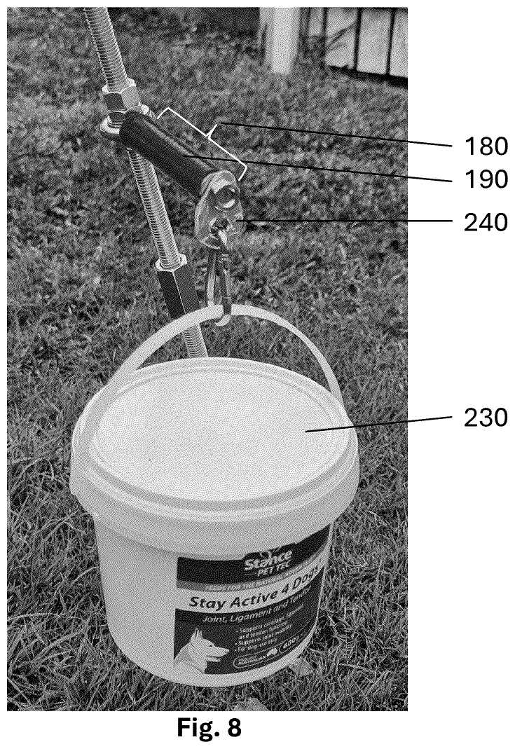

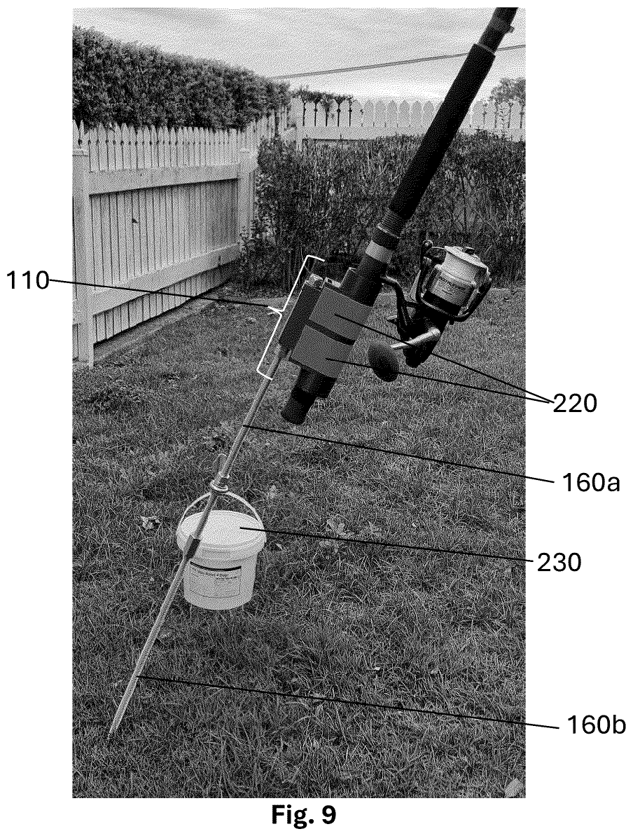

In a preferred embodiment, the standard height of the staking assembly (140) is 100 cm, although this height is fully adjustable and may be extended to double this length by connecting the staking assembly (140) to a second staking assembly (140), or may be less than this length, if desired. For example, the height of the staking assembly may be extended to 150 cm, simply by securing another hex joiner. Elevating the staking assembly is particularly useful in scenarios whereby the fishing rod holder is to be secured to shallow water or rocky riverbanks, as this allows the bait bucket (230) (FIG. 8) to be positioned above the water surface (see for example FIG. 8).

The staking member is a separable member including an upper staking member (160a) and a ground staking member (160b) connected by a connecting arrangement (FIGS. 1, 5-7, 9). The connecting arrangement connects the two members at their respective ends. The connecting arrangement takes the form a threaded hex nut (161). The ground staking member (160b) which is substantially unthreaded includes a threaded portion (not shown) at an end to be received within the hex nut (161). Thus, the threaded ends of the first threaded member (160a) and the ground staking member (160b) can be threaded into the hex nut (161) to connect the two members together.

The separable embodiment of the staking members can therefore be extended by providing a third member (not shown) that is threaded at both ends (and, in some embodiments, threaded along its entire length) and a second hex nut where the third member is then located between the upper staking member (160a) and the ground staking member (160b) and connected to each of those members at opposed by one of the two hex nuts.

In a preferred embodiment, only one end of the ground staking member (160b) is threaded with the opposite end being unthreaded. This ensures that, in use, when the ground staking member (160b) is driven into the ground (which may be coarse sand or hard rocks) that the threaded portion is protected and will not suffer from wear and smoothing over time.

To assist with inserting the staking assembly (140) into the ground surface, it is preferable for the staking assembly (140) to further comprise a foothold (180), wherein the foothold (180) may be substantially perpendicular to a longitudinal axis A-A of the staking assembly (140) (FIG. 5).

The foothold (180) may be covered with a protective or insulating layer (190) to provide some cushioning effect to the fisherman when pressure is applied to the foothold (180). For example, the protective layer (190) may be a heel guard, which minimizes or prevents injury to the foot when pushing the staking assembly (140) via the foothold (180) into the ground, using force as applied by the fisherman's bare foot, which is often the scenario when beach fishing. The protective or insulating layer (190) may be resistant to water, UV or other potentially damaging effects from the natural environment, such as salt or acidic water.

The protective layer (190) can also be provided in a variety of colours that can be either colour matched, or colour mixed with the corresponding rod holder portion (110) and/or resilient collar (130) to thereby allow each fisherman to have a uniquely coloured rod holder assembly amongst multiple holders (FIGS. 1, 5-8).

The foothold (180) may be located anywhere along the length of the staking assembly (140), preferably between the first end, which is connected to the rod holding portion (110) and the second end, which engages with the ground surface (FIG. 5). In other words, the foothold (180) may be height adjustable along the length of the staking assembly (140), according to the fisherman's preferences. The position of the foothold (180) is also adjustable, for example it could be protruding substantially perpendicular to the staking assembly on either the left or the right side of the staking assembly (140). The presence of the foothold (180) enables a fisherman to drive one end of the staking assembly (140) into the ground surface using a pushing force from their leg when resting their foot on the foothold (180). The foothold (180) therefore offers a convenient means to push the staking assembly into the ground without requiring to the fisherman to bend their upper body to perform the same action (FIGS. 1, 5-8).

The staking assembly (140) may further comprise a handle (not shown) in addition to the foothold (180), to further assist with inserting the staking assembly (140) into the ground surface, as the fisherman could use the handle (not shown) to help lift and easily move the staking assembly (140) to a desired location before utilising the foothold (180) for driving the end of the staking assembly (140) into the ground surface. The handle may also assist the fisherman with removing the staking assembly (140) from the ground surface after fishing or to reposition the staking assembly (140) during fishing activities, upon exerting an upward pulling action on the handle.

The handle (not shown) may be of any suitable means, for example similar to the foothold (180), it may be substantially perpendicular to a longitudinal axis A of the staking assembly (140). Alternatively, the handle may be a closed loop wherein first end of the handle connects to the staking assembly (140) at one position along the length of the staking assembly (140), with the second end of the handle connecting to the staking assembly (140) at a second position along the length of the staking assembly (140), above or below the position of the first end of the handle. Similar to the foothold (180), the handle may also be covered with a protective or insulating layer (190) to provide some cushioning effect to the fisherman when pressure is applied to the handle to minimize or prevent injury to the hand when pushing the staking assembly (140) via the handle into or out of the ground. The protective or insulating layer may be resistant to water, UV or other potentially damaging effects from the natural environment, such as salt or acidic water. Furthermore, the positioning of the handle is adjustable along the length of the staking assembly, similar to that of the foothold described above.

The handle (not shown) or foothold (180) may also permit the removable attachment of a clip (240) that allows a bait bucket (230) to be secured thereto (FIGS. 8 and 9). The clip (240) may be attached to the handle or foothold (180) by any suitable means, for example there may be loop or aperture along the length of the handle or foothold (180) through which the clip (240) may pass through. Alternatively, and as seen in FIG. 8, the clip may have an aperture that is received by the peripheral end of the handle or foothold (180) and which is secured in place, or at least prevented from sliding off the end of the handle or foothold (180), by presence of a bolt or other type of fastener. The peripheral end of the handle or foothold (180) may in some embodiments be threaded to engage with the threading of the bolt or fastener. Having the feature of a removable clip that may be attached to a peripheral end of a handle or foothold (180) is beneficial to provide a convenient way for storing, for example, a bait bucket (230) without having it placed on the ground, which may be uneven (in the case of rocky banks) or may be easily knocked over. Furthermore, the capability to securely attach a bait bucket (230) to a handle or foothold (180) of a staking member (140), minimizes any confusion that may arise as to the type of bait hooked on the fishing line, particularly if multiple fishing rods are being used in the area to catch different types of fish.

In an embodiment, the staking assembly (140) has properties of high tensile strength so that it is resistant to bending, and it is also desirable for the staking assembly (140) to be resistant to corrosion and other natural elements. For example, it may be UV-resistant and/or resistant to acidic or salt water, so that the attachment means may be repeatedly reused without significant deterioration, thus imparting qualities of high durability.

The staking assembly (140) may be manufactured using aluminium, a structural grade alloy which is lightweight whilst being strong and resistant to corrosion.

Any fastening means (150) such as nuts, or other stoppers that may be used together with the staking assembly (140), would also be manufactured using the same metallic material.

Use of aluminium may be used as this would eliminate electrolysis, which is understood in the art to occur when two different metal compounds are used together. For example, when using an aluminium rod with stainless-steel nuts. In another example, pins for connecting the aluminium rods may be used.

However, other materials may be used including stainless steel and carbon fibre either solely or in combination. For example, carbon fibre or a combination of carbon fibre and aluminium for various components may be used to provide strength, lightness and rigidity.

In an embodiment, there may be a storage compartment (200) (FIGS. 2 and 4) for storing accessories that may be useful when fishing. Preferably the storage compartment (200) would be integrated into the rod holding portion (110), so to minimize the number of attachments to the fishing rod assembly, although it may also be provided separately as an optional feature, to offer a more compact and portable fishing rod holder that may also be lighter in weight.

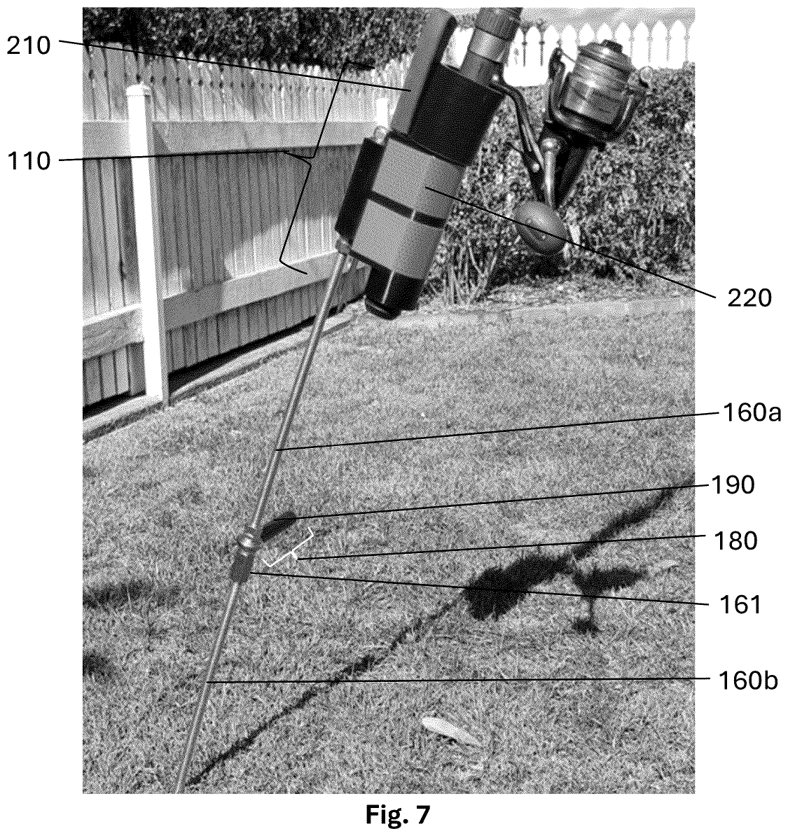

The storage compartment (200) (FIGS. 2 and 4) may accommodate storage of a knife (210) (FIGS. 6 and 7), which otherwise may be placed on the ground nearby or in the sand when fishing. Having a storage compartment (200) could therefore enhance the safety of fishermen whilst fishing on land. The storage compartment (200) may be of any suitable size or shape, for example, in the case of providing storage for a knife (210), the storage compartment (200) may be a knife slot having an open upper end to allow a knife (210) to slide into the compartment.

In an embodiment, the rod holding portion (110) may be furnished with visual indicia (220) on its exterior surface. The visual indicia (220) may be any suitable visual indicia, for example, its application to the exterior surface of the rod holding portion (110) may provide the rod holding portion (110) with an aesthetically pleasing appearance (FIGS. 1, 5-7, 9).

The visual indicia (220) may be interchanged to allow a fisherman to personalise their fishing rod holder, which may be useful in helping to identify the fishing rod holder and to distinguish it between other fishing rod holders that may be present, particularly in areas of popular fishing spots (FIGS. 1, 5-7, 9). In scenarios whereby the fisherman may have multiple fishing rod holders, having the option to change the visual indicia (220) on the exterior surface of the fishing rod holding portion (110) may also serve as a reminder to the fisherman as to the different types of baits that may be attached at the end of the fishing hooks, especially if the bait bucket is not attached to the peripheral end of the handle or foothold (180).

The visual indicia (220) may provide a contrasting colour to the colour of the rod holding portion (110) and, in some cases, includes reflective tape or other materials that visually assist with identifying the fishing rod holder under limited lighting conditions. For example, in some embodiments, the visual indicia (220) may include tape that glows-in-the-dark. In a preferred embodiment, the visual indicia are reflective tape and is positioned at the back of the rod holding portion, thereby rendering the rod holding portion (110) highly visible in the presence of standard use head lamps and infrared light, having a visibility of 50 metres or more. The reflective tape is a class 400 T product, conforming to AS/NZS 1906.1:2017 standards (FIG. 6).

In use, insertion of the staking assembly (140) into the ground surface would secure the fishing rod holding portion (110) in a substantially upright orientation from the ground (FIGS. 1, 6, 7, 9).

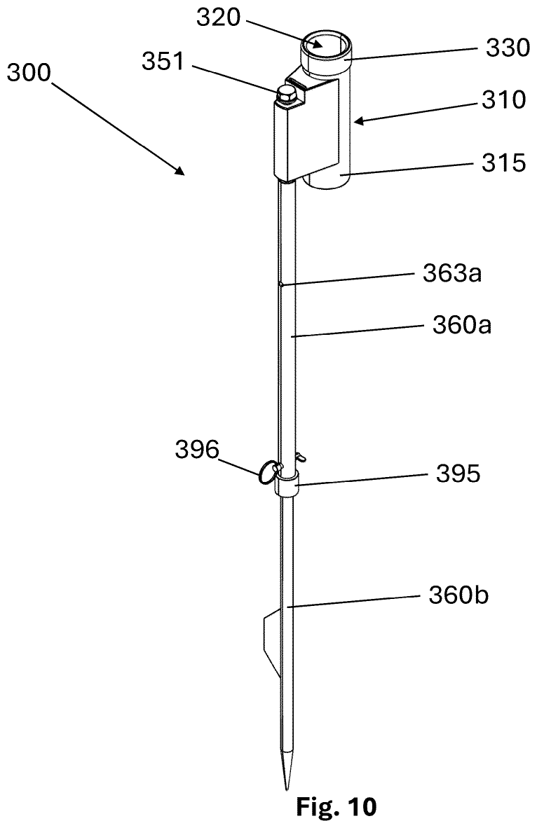

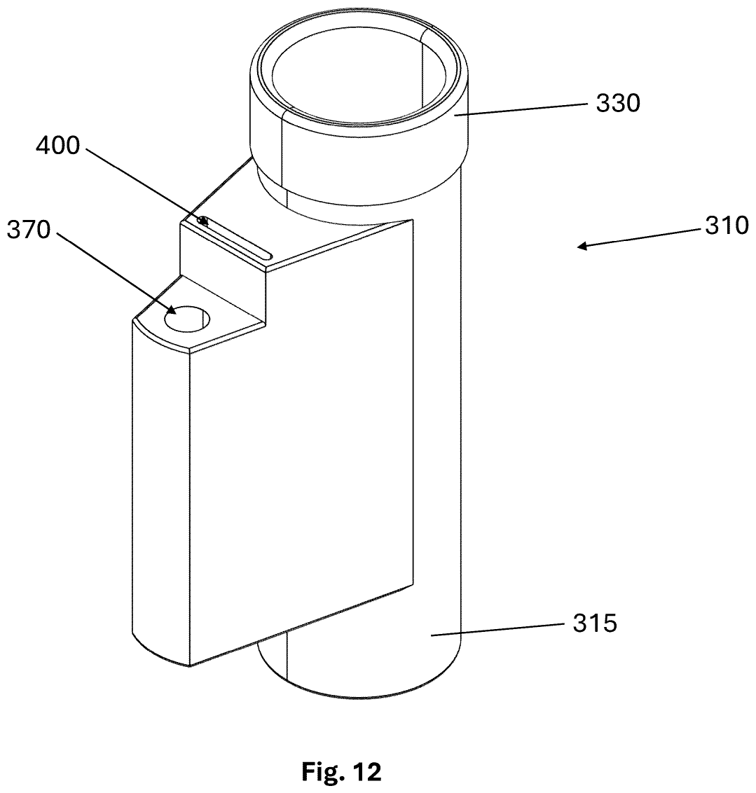

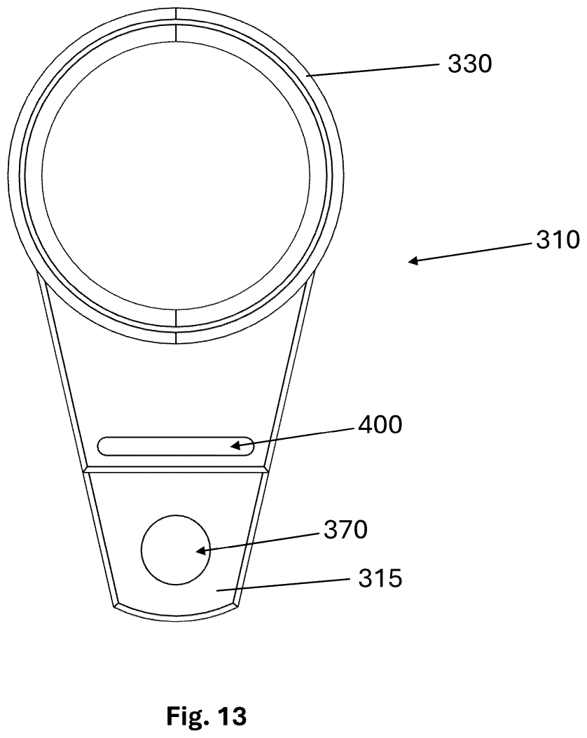

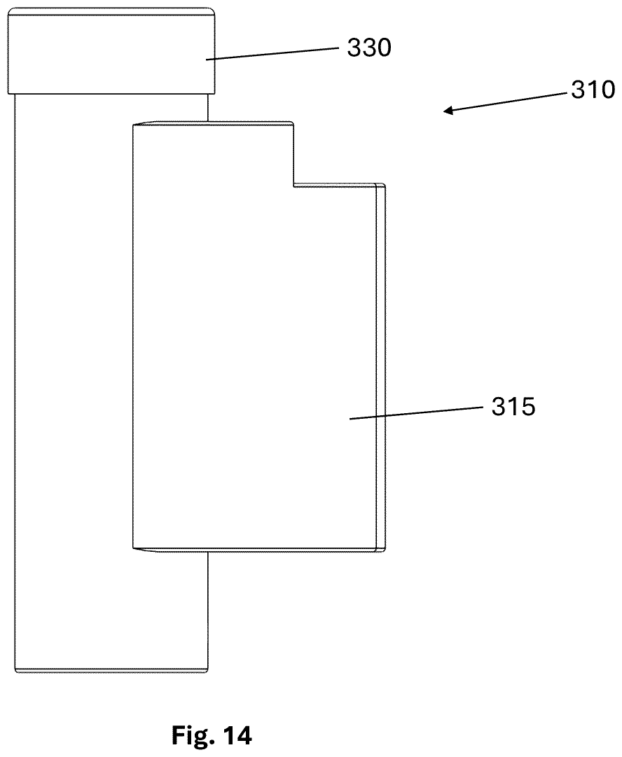

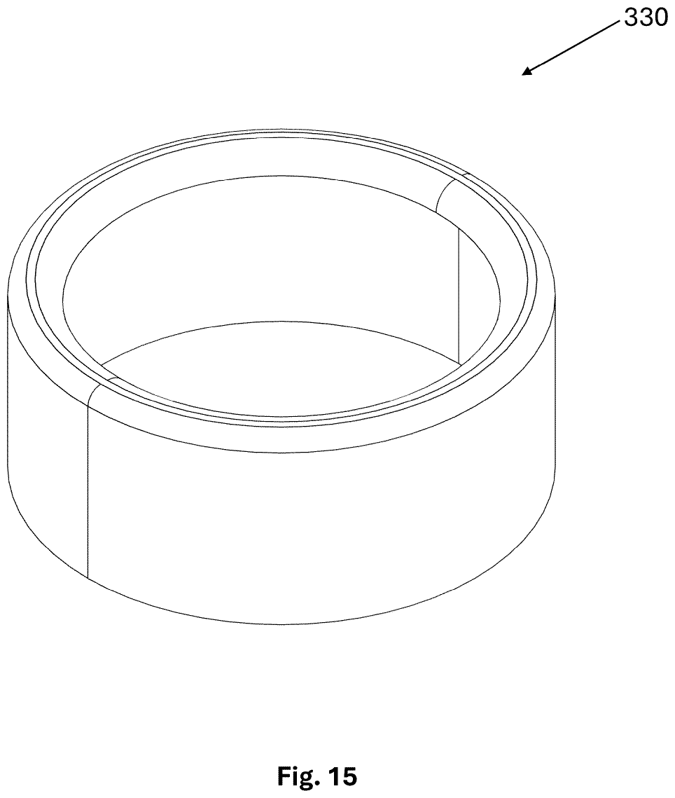

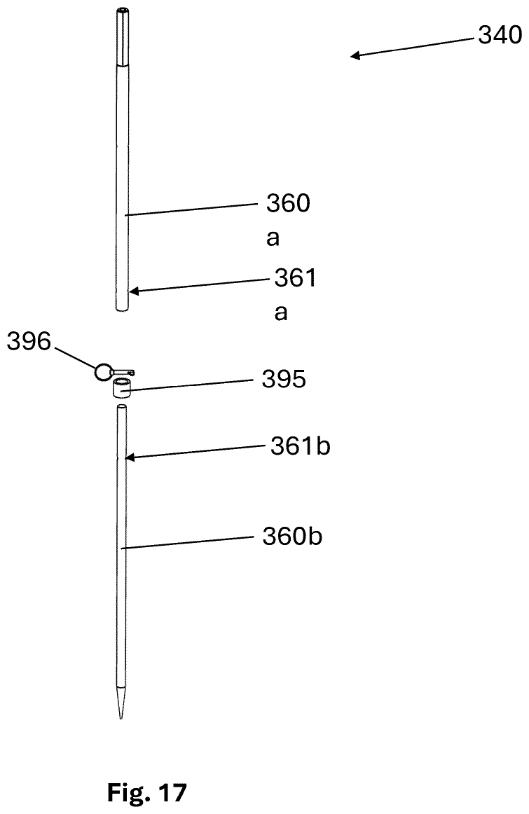

Turning to FIGS. 10 through 19, there is shown another embodiment of a fishing rod holder assembly (300). The fishing rod holder assembly (300) includes a rod holding portion (310) and a staking assembly (340).

The rod holding portion (310) includes a body (315) with a rod passage (320) for receiving a fishing rod handle and a staking assembly (340) in the form of a plurality of staking members (to be described below) for connecting to and orienting the rod holding portion (310) relative to the ground (or another surface).

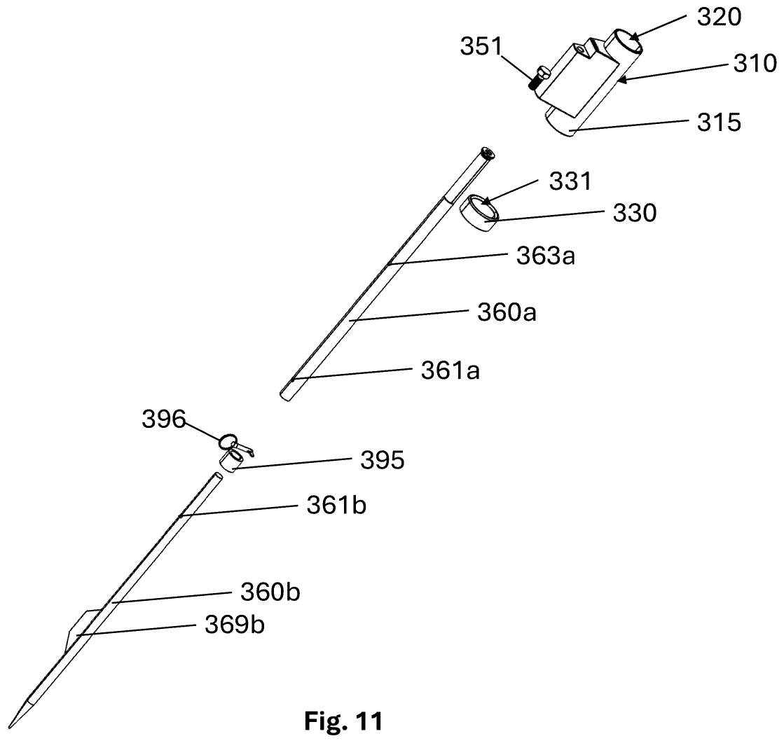

At one end of the rod passage (320) there is provided a resilient collar (330), having a passage (331) therethrough (FIGS. 11 through 19).

The resilient collar (330) may be removable and, in use, is placed to receive an end of the upper end of a portion of the body (315) defining the rod passage (320) in a way that aligns the passage (331) of the resilient collar (330) with the rod passage (320), such that the handle end of the fishing rod may pass through the passage of the resilient collar (330) before being received within the rod passage (320). Put another way, the resilient collar (330) is an open-ended cylinder having an annular lip or projection at one end configured to abut the upper end of the body (315) that defines the passage (320).

The resilient collar (330) may be made of, or lined with, any suitable material that provides a cushioning and supportive effect whilst maintaining its shape without being substantially deformed by the application of pressure. In particular, the resilient collar (330) should minimally deform or compress when pressure when pressure or forced is applied at the ends of the resilient collar (330). For example, the resilient collar (330) may be made of rubber and/or have a rubber lining along at least a portion of the interior passage of the collar. Other types of materials that may also be used include for example, shape-memory polymer materials, such as polyurethane or synthetic foam or a lining made of the same, various resilient plastics or gel-like materials may also be used. This provides protection for the reel of the fishing rod when it is placed within the fishing rod holder and would other abut the rod holding portion directly, which may cause damage to the expensive reel.

The rod holding portion (310) and the resilient collar (330) may be provided in a range or variety of colours such that the rod holding portion (310) can be matched to a resilient collar (330) having the same colour, or different colour combinations can be used to provide distinction between other rod holders that may be in use, such as when a group of fishermen are fishing together or a family has multiple rod holders.

In an embodiment, there may be a storage compartment (400) for storing accessories that may be useful when fishing. Preferably the storage compartment (400) would be integrated into the rod holding portion (310), so to minimize the number of attachments to the fishing rod assembly, although it may also be provided separately as an optional feature, to offer a more compact and portable fishing rod holder that may also be lighter in weight.

The storage compartment (400) may accommodate storage of a knife or a ruler, for example, which otherwise may be placed on the ground nearby or in the sand when fishing

The rod holding portion (310) may be secured in position by a staking assembly (340). The staking assembly (340) may be any suitable means that would permit securing the fishing rod holder to the ground surface when the staking assembly (340) is fitted via a connecting arrangement to the rod holding portion (310).

The staking assembly (340) includes two staking members which may be a spike, stake or may be pronged at one end to allow a user to insert and anchor the tapered end into the ground to a sufficient depth so that the fishing rod holding portion (310) will be secured to sufficiently support and hold the weight of a fishing rod held within the fishing rod holder.

The two staking members of staking assembly include an upper staking member (360a) having a first end for connecting to the holding portion and a second end for connecting to another staking member (such as the ground staking member (360b), and a ground staking member (360b) having a first end for connecting to another staking member (such as the upper staking member (360a) and a second end for engaging a ground surface.

The upper staking member (360a) is substantially hollow, or at least has a hollow portion, to allow an end of the ground staking member (360b) to be received therein.

The ground staking member (360b) is substantially solid. This provides weight, strength and rigidity to the ground staking member (360b) when engaging the ground and helps stabilise the fishing rod holder.

The second end of the ground staking member (360b) is substantially concial (or pointed or spiked) to assist with driving the member into the ground.

When the fishing rod holder is assembled, the second end of the upper staking member 360a is connected to the first end of the ground staking member 360b. In the illustrated embodiment, the connecting arrangement takes the form of a pin (396) and apertures (361a, 361b) arranged in the first and ground staking members (360a, 360b).

To connect the upper staking member (360a) and ground staking member (360b) together, the ground staking member (360b) is telescopically received within the upper staking member (360a). The upper staking member (360a) and ground staking member (360b) both include apertures therein, which, when aligned, allow for a pin (396) (such as a locking pin or similar device) to be inserted through the aligned apertures to secure the upper staking member (360a) to the ground staking member (360b).

A rubber seal (395) or a mechanical seal may be located at the second end of the upper staking member (360a) so when the ground staking member (360b) (that may be solid) is pushed inside no sand can enter the inside of the upper staking member (360a).

In use, the first end of the ground staking member (360b) engages the ground surface to secure the fishing rod in position.

The upper staking member (360a) is connected with the rod holding portion via a connecting arrangement.

The connecting arrangement may include a fastening assembly (350) that coordinates with the upper staking member (360a) to releasably secure the rod holding portion (310) to first end of the upper staking member (360a). The fastening assembly (350) includes a threaded bolt (351) that is received through a staking passage (370) of the rod holding portion (310). The upper staking member (360a) is received within the rod holding portion at an opposed end of the staking passage (370). The first end of the upper staking member (360a) is internally threaded so that the threaded bolt (351) and upper staking member (360a) can be connected together to secure the rod holding portion (310) to the upper staking member (360a).

The peripheral end of the staking member may be threaded for a length of 40 mm or for any other suitable length.

The ground staking member (360b) may include a fin (369b) that protrudes from the ground staking member (360b). The fin (369b) may be welded or other securely connected to the ground staking member (360b).

The fin (369b) helps to prevent the ground staking member (360b) from spinning when inserted into the ground and, in particular, when inserted into sand. Sand, and other materials in the ground, can be abrasive which wears the staking member over time. Therefore, by preventing, or at least limiting, the movement of the ground staking member (360b) when in the ground, this abrasion can be reduced.

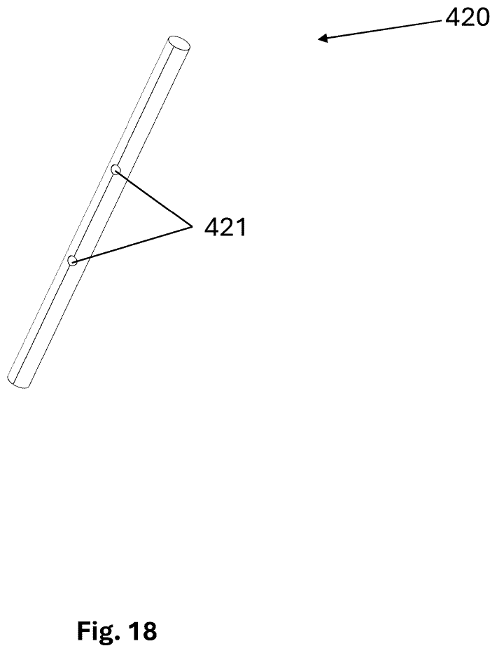

Turning briefly to FIG. 18, an extension member (420) is shown. The extension member (420) may be used as an intermediary member to connect the upper staking member (360a) to another/additional upper staking member (not shown). As can be seen, the extension member (420) includes apertures (421). These apertures (421) are configured so that when the extension member (420) is inserted into the upper staking members (360a), the apertures (421) can be aligned with the respective apertures of the upper staking members (360a) so that a pin (or other connecting device) can be inserted therethrough to connect the extension member (420). An end of the one of the upper staking members (360a) not connected to the rod holding portion (310) can then be connected to a ground staking member (360b) as described throughout this disclosure. As the upper staking members (360a) are either substantially hollow or entirely hollow, connecting multiple upper staking members (360a) allows for the assembly to be useful across a greater number of scenarios (such as fishing from rocks, for example) without significantly increasing the weight or sacrificing the strength and rigidity provided by the ground staking member (360b).

A peripheral device, such as a bait board 410 or cutting board, can be connected to the first end of the upper staking member such that the peripheral device is located between the threaded bolt and the rod holding portion.

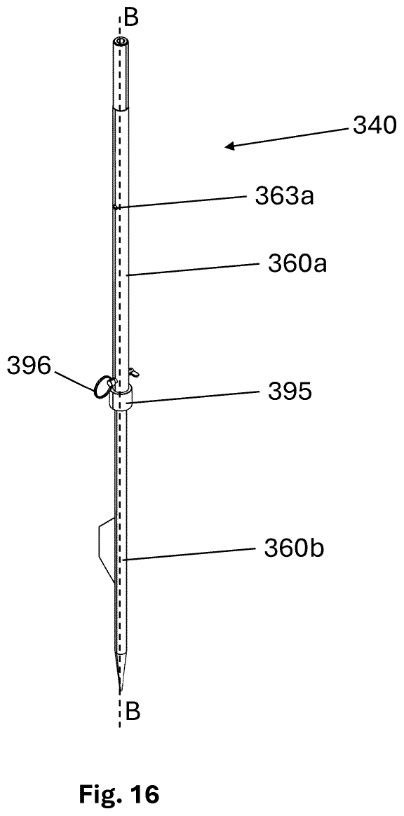

The staking assembly (340) may also include a foothold (380) or handle (discussed later) to assist with inserting the staking assembly (340) into the ground (FIG. 16).

The foothold (380) may include a foothold member having a passage therethrough such that one of the staking members can be inserted through the passage. The staking members and the foothold member may each include apertures that, when aligned by inserting the appropriate staking member through the passage of the foothold member, allow for a securing pin (such as a locking pin) to be inserted through the aligned apertures to secure the foothold and the staking member together. In the illustrated embodiment, the upper staking member (360a) includes aperture 363a and the foothold (380) includes aperture (381). In use, these apertures are aligned and a locking pin (382) or other suitable securing member is inserted through the apertures to connect the foothold to the upper staking member (360a).

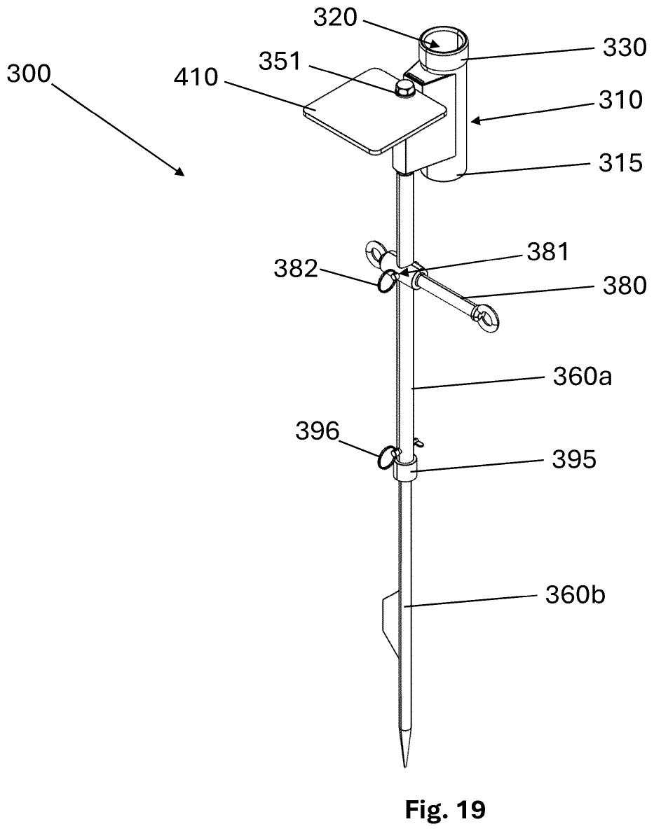

In use, the foothold (380) may be substantially perpendicular to a longitudinal axis B-B of the staking assembly (140) (FIG. 19).

The foothold (380), or a portion thereof, may be covered with a protective or insulating layer to provide some cushioning effect to the fisherman when pressure is applied to the foothold (380). For example, the protective layer may be a heel guard, which minimizes or prevents injury to the foot when pushing the staking assembly (340) via the foothold (380) into the ground, using force as applied by the fisherman's bare foot, which is often the scenario when beach fishing. The protective or insulating layer may be resistant to water, UV or other potentially damaging effects from the natural environment, such as salt or acidic water.

The handle (not shown) or foothold (380) may also permit the removable attachment of a clip (such as a carabiner, for example) that allows a bait bucket to be secured thereto (see FIGS. 8 and 9 from the earlier described embodiment). The clip may be attached to the handle or foothold (380) by any suitable means, for example there may be loop or aperture along the length of the handle or foothold (380) through which the clip may pass through. The peripheral end of the handle or foothold (380) may in some embodiments be threaded to engage with the threading of the bolt or fastener. Having the feature of a removable clip that may be attached to a peripheral end of a handle or foothold (380) is beneficial to provide a convenient way for storing, for example, a bait bucket without having it placed on the ground, which may be uneven (in the case of rocky banks) or may be easily knocked over. Furthermore, the capability to securely attach a bait bucket to a handle or foothold (380) of a staking member (340), minimizes any confusion that may arise as to the type of bait hooked on the fishing line, particularly if multiple fishing rods are being used in the area to catch different types of fish.

Components of the fishing rod holder may be disassembled into parts for ease of storage when the fishing rod holder is not in use. This also assists with ease of transport to and from fishing sites.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A fishing rod holder assembly comprising:
a rod holding portion comprising a body having a rod passage for receiving a handle end of a fishing rod; and
a staking assembly comprising:
an upper staking member having a first end for connecting to the rod holding portion and a second end for connecting to another upper staking member or a ground staking member; and
a ground staking member having a first end for connecting to an upper staking member and a second end for engaging a ground surface,
wherein:
the second end of the upper staking member is releasably connected to the first end of the ground staking member,
the first end of the upper staking member is releasably connected to the rod holding portion.

2. An assembly according to claim 1, wherein the rod holding portion comprises a removable resilient collar that abuts or receives an end of the body of the rod holding portion defining the rod passage and wherein the resilient collar defines a passage for receiving a handle end of a fishing rod therethrough such that, in use, the handle end of the fishing rod passes through the passage of the resilient collar and is received within the rod passage.

3. An assembly according to claim 1, wherein the upper staking member is releasably connected to the rod holding portion via a connecting arrangement and the connecting arrangement comprises: a staking passage formed in the body of the rod holding portion; and a fastening assembly, wherein the upper staking member extends through the staking passage and the fastening assembly connects to the upper staking member for securing the rod holding portion to the upper staking member.

4. An assembly according to claim 3, wherein the upper staking member is internally threaded at an end to threadedly engage with a fastener of the fastening assembly.

5. An assembly according to claim 1, further comprising a foothold connected to the staking assembly and oriented substantially perpendicular to a longitudinal axis of the staking member.

6. An assembly according to claim 1, wherein the first end of the ground staking member is received within the second end of the staking member.

7. An assembly according to claim 1, wherein the upper staking member is at least partially hollow to receive the first end of the ground staking member therein, and the ground staking member is substantially solid.

8. An assembly according to claim 1, wherein the rod holding portion comprises visual indicia on an exterior surface.

9. An assembly according to claim 8, wherein the visual indicia comprises reflective tape.

10. An assembly according to claim 1, wherein the second end of the ground staking member for engaging the ground surface is tapered or conical.

11. An assembly according to claim 1, wherein the passage of the body of the rod holding portion is open at least at one end for receiving a handle end of a fishing rod.

12. An assembly according to claim 1, wherein the rod holding portion further comprises a storage compartment for receiving accessories therein.

13. An assembly according to claim 12, wherein the storage compartment is a slot formed in the body of the rod holding portion.

14. An assembly according to claim 5, wherein the foothold is adjustably positionable along the staking assembly.

15. An assembly according to claim 5, wherein a clip is removably attachable to the foothold for connecting to and holding an external accessory.

16. An assembly according to claim 1, further comprising an extension member and an additional upper staking member, wherein the extension member connects the upper staking member to the additional upper staking member, and the additional upper staking member is connected to the ground staking member.

17. An assembly according to claim 1, wherein the ground staking member comprises a fin connected thereto to limit rotation of the ground staking member when engaged with the ground.

18. A method of assembling a fishing rod holder, the method including:
providing a staking assembly comprising an upper staking member having a first end and a second end and a ground staking member having a first end and a second end;
providing a rod holding portion, the rod holding portion including a body having a rod passage configured to receive a handle end of a fishing rod, wherein the rod holding portion is connected to the first end of the upper staking member;
connecting the second end of the upper staking member to the first end of the ground staking member; and
engaging the second end of the ground staking member with a ground surface to secure the fishing rod holder in position.

19. A method according to claim 18, wherein the method includes connecting the first end of the upper staking member to the rod holding portion.

20. A method according to claim 18, wherein the method includes:
providing an extension member and an additional upper staking member;
wherein connecting the second end of the upper staking member to the first end of the ground staking member includes connecting the upper staking member to the additional upper staking member, and connecting the additional upper staking member to the ground staking member whereby the additional upper staking member connects the upper staking member to the ground staking member.
